(19) United States
(12) Patent Application Publication
(10) Pub. No.: US 2009/0156031 A1
(43) Pub. Date: Jun. 18, 2009

(54) Coupler Assembly for a Scalable Computer System and Scalable Computer System

(75) Inventors: Dieter Staiger, Fulkenstrasse (DE); Harald Huels, Verbindungsweg (DE)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/954,488

(22) Filed: Dec. 12, 2007

(51) Int. Cl. H01R 13/66

(52) U.S. Cl. 439/151

(57) ABSTRACT

The invention relates to a coupler assembly for electrically coupling at least two boards (200a, 200b, 200c, 200d) comprising interconnected integrated circuits, which coupler assembly provides high-speed constrained electrical interconnection (130) between the coupled boards (200a, 200b, 200c, 200d), for example CPU-busses, SMP-busses and IO-busses. The electrical interconnection (130) provides signal timing alignment and signal integrity for signals exchanged between the coupled boards (200a, 200b, 200c, 200d).

### BACKGROUND OF THE INVENTION

The invention relates to a coupler assembly for a computer system and a computer system.

Since the end of the 1980s symmetric multiprocessing is one of the most commonly used standard architecture for computer systems with multiple processors. A symmetric multiprocessing system (SMP) describes a method for processing of programs by multiple processors that share a common operating system and memory. In symmetric—also called “tightly coupled”—multiprocessing, the processors share memory and the I/O bus or data path. On SMP systems a single copy of the operating system is in charge of all the processors belonging to the multiprocessing system. SMP systems are also known as “shared everything” systems.

Entry level servers and workstations with two processors operating as CPUs (Central Processing Units) in SMP architecture dominate the today's SMP market. In principle, there is no limit for the number of processors linked to build an SMP system. The inevitable intercommunication of the combined CPU's, however, requires high bandwidth SMP busses to effectively take advantage of the linked CPU's.

Since all processors of an SMP system share the common memory, the memory bandwidth is as well a critical factor for the performance of an SMP system.

Typically, today's mid-level servers are using between four and eight processors. High-end systems are built up in combining sixteen or more processors. Besides an increased overall system performance, an important advantage of SMP is the ability to dynamically balance the workload among the respective computers and as a result serve more users faster.

A standard single Blade server known in the art is occupying a single board position within a rack of a Blade Center system. Typically, a Blade unit comprises a motherboard, a frame, connectors and a number of slots for additional add-on boards. A Blade server board may hold multiple CPUs on board thus enabling Symmetric Multiprocessing (SMP). Applying today's advanced multi-core processors enables to build a multi-way SMP Blade server.

However, the SMP capabilities of standard Blade server boards are restricted by two general constraints, the single Blade server board maximum power consumption and the available board space. In case an extended SMP is required, dedicated Blade server systems have to be developed.

Depending on the system electronics board form factor a single CPU board can already provide multiple CPU sockets and furthermore, each CPU socket can accommodate a multi-core processor module. As an example, Blade servers are featuring specific expansion connectors on the motherboard allowing to expand the system by a dedicated daughter board, i.e. thus today scaling up to build an 8-way multiprocessing Blade.

The SMP-bus connection linking the processors on the motherboard to the processors on the daughter board is critical to the SMP system performance. To ensure functionality it is essential to guarantee matched signal propagation delay for all SMP bus signals within tight tolerances.

For this reason the SMP bus signal traces on the motherboard connecting the CPU pins to the SMP connector are required to have matched printed circuits wiring trace lengths. The same requirement is given for the SMP daughter board.

The typically high pin count of modern processor modules make it difficult to escape the signals from the module SMP bus pins and to wire the SMP bus traces in matching trace length to the SMP connector thus aggravating the physical board design. Power and cooling issues that come up during the computer system design enforcing heat-sinks with their big footprints occupying as much as a quarter of the effective real estate of a Blade server board are creating even more difficulties for the physical design. High current power supplies need a huge amount of copper and occupy entire layers to distribute their voltages. As a sub-consequence of these layers a high amount of board vias are distributed across the entire board—hindering traces on other layers to follow a straight connection. As a consequence the described typical situation causes additional trace length just to maneuver around the power vias in order to connect the high speed signals as well system performance appointing board wiring connecting the CPUs to the system memory are located in the same physical board area.

If high system performance is the objective, which is typically the key for extended SMP systems, no performance loss can be tolerated. Expensive system boards with increased number of board layers are the consequence.

Specific motherboard/daughter board system designs are known. However, these exhibit a reduced system upgrade capabilities and reveal problems in static system configuration.

Typically, coupling two boards is accomplished by connecting the boards face-to-face via mating connectors which are placed on the boards. This means that at least two different types of boards (for example one with a male and one with a female connector) have to be provided instead of generic boards.

Additionally, the mechanical design of dedicated motherboard/daughter board mechanical system chassis is laborious and expensive. For example, if a single wide chassis has to be expanded for a dual wide system. The maintenance handling is aggravated with respect to mechanical handling and the dual-wide system weight.

Typically, the SMP width applicability is limited. For “wider” SMP configurations the solutions become much more expensive.

A scalable computer system made of subsystems is disclosed in US 2004/0066249 A1. Coupling between two or more subsystems is performed by capacitive contacts. The subsystems communicate with each other via surface-mounted capacitive couplers located on the subsystem surfaces.

Microprocessors with SMP capability in SMP-clusters are connected via special SMP busses, which usually can be standardized. The access to common resources, such as common memory, for example, is controlled by coherence protocols. If a SMP connection has to be established comprising a multitude of boards, problems arise because of restricted minimum signal propagation time skews within the coupled systems.

Typically, solutions for such SMP connections are complex motherboard/daughter board designs with very large motherboards The motherboards have to implement the signal delay matches which are necessary for the physical connections, thus increasing the board design complexity, for example with many additional layers in the PCB (printed circuit board).

### SUMMARY OF THE INVENTION

It is an object of the invention to provide a coupler assembly for a computer system as well as a computer system, which allows for less complex board designs when boards with interconnected integrated circuits are coupled.

The object is achieved by the features of the independent claims. The other claims and the specification disclose advantageous embodiments of the invention.

According to the invention, a coupler assembly is provided for electrically coupling at least two boards, which boards comprise integrated circuits, and which coupler assembly provides high-speed constrained electrical interconnection between the coupled boards, wherein the electrical interconnection provides signal timing alignment and signal integrity for signals exchanged between the coupled boards. The coupler assembly itself can comprise integrated circuits and a complex design. However, as the coupler assembly can be made much smaller than the coupled boards, even highly complex integrated circuitry on the coupler assembly can be tolerated at attractive cost. The coupled motherboards, on the other hand, do not need to provide for exact signal matches. All coupled boards can be physically and electrically identical, thus enabling using generic boards for a scalable computer, which is cost efficient. In principle, all signal integrity constraints can be solved in the coupler assembly.

Additionally, a board-spanning expansion is not limited to two system boards. In principle, the coupler assembly can be implemented to couple as many coupled motherboards as required.

As the coupler assembly is very small, high electrical signal quality materials can be used without increasing manufacturing costs distinctly. For example, a low loss dielectric board material such as PTFE (polytetrafluorethylene) can be used. Thus transferring the timing critical signal wiring to the coupler, a cheaper material can be used for the coupled motherboards.

The basic function of the coupler assembly according to a preferred embodiment of the invention is to provide a high-speed connection between SMP-extended Blade server boards. The SMP-bus wiring on the motherboard itself does not need to follow the SMP-signal timing specifications and, therefore, can be done with least expense on lowest budget. Instead, the coupling board provides adjustment of the signal timings to the SMP-bus specified signal delay consistency and alignment.

Favorably, multiple Blade server boards or comparable server boards can be coupled via the coupler assembly to build up board spanning extended Symmetric-Multiprocessing systems. Although the coupled Blade boards require being designed specifically in order to support the coupling, only a minimum overhead is necessary to support extended SMP on a standard system motherboard. It is a key advantage that the coupler assembly does not require costly and complex changes or electronics and mechanical additions for the system board. Therefore, the standard Blade server motherboard can be kept at low cost. The cost adders to build up a scalable computer system, preferably an extended SMP system, are moved to an optional coupler assembly, especially an SMP-coupler board. The coupler assembly can be added to or removed from the computer system on customer and/or application demand.

The required design upgrade to enable standard Blades or similar processing boards for the coupler assembly expansion solution is kept at a minimum. This design upgrade is only a negligible cost adder to the motherboard and, therefore, allows having the coupler assembly, preferably as an SMP-coupler device, “precondition” implemented on each standard board. Generic boards can be used, because they only need one type of connector, whereas the coupler assembly provides the mating connectors for the interconnection of the coupled boards. The effort for redesigning standard boards, such as Blade server boards for example is minimized with negligible additional planar board wiring requirements. A cost-effective n-way expansion capability, especially an n-way SMP expansion capability, on minimum system infrastructure overhead can be achieved.

The Blade application can be extended to an n-way-SMP on demand.

Additionally, the coupler assembly can be used as an additional access point to the coupled boards. Further, the coupler assembly is a system-planar external device with an ideal place/system planar access point to enable after-sales customer driven requirements and/or solutions.

The coupler assembly device can be added on requirement combining the respective motherboard to build up an extended system, such as an SMP system. Although the coupler assembly is a technically ambitious component, the coupler assembly option allows building up extended systems in very attractive costs. If the coupler assembly is removed from the system, the motherboards can be quickly restored to their origin if desired.

According to another preferred embodiment of the invention, the coupler assembly can be used to couple I/O-boards. These can but do not necessarily have active devices such as CPUs on board.

Favorably, the coupler assembly provides a signal delay circuitry. This is especially preferred for coupling boards with an SMP-capability.

Also favorably, the coupler assembly provides an impedance matching circuitry. This is especially preferred for coupling I/O-boards.

A standardized set-up is possible, if the coupler assembly provides one connector for each coupled board. This is still better accomplished if the connectors are arranged on a coupler board in an equidistant relationship to each other.

One connector can provide coupling of at least two connection types between at least two coupled boards. In a preferred embodiment, one connector can provide coupling for an SMP extension as well as an extension for I/O-connections.

Preferably, the interconnection between the connectors is a high-speed interconnection. High quality board materials can be used with still tolerable manufacturing costs.

According to a favorable embodiment, the assembly is designed as a passive device. Several variations of coupling can be provided. The wiring and the number of interconnections, respectively, on the coupler board can be adapted accordingly. For passive systems it is possible to apply a high performance planar technology building up a complex 20+ layer-planar PCB. The high number of layers is used to extend the usable wiring real-estate, allowing adjusting the overall signal-path to meet the signal integrity specification. For example for SMP-extension, signal timings to the SMP-bus specified signal delay consistency and alignments can be adjusted.

According to another favorable embodiment, the assembly can comprise at least one active device. Most preferably, the assembly can be adapted to be programmable. Preferably, the coupler board comprises at least one switch. One benefit of the active coupler assembly is the capability defining and/or configuring the coupler span of the system controlled by a system control program. The number of coupled boards can be changed on demand. It is possible to couple boards only temporarily or to change the number of coupled boards during processing. In case active logic control circuitry is required to build up the scalable system, the respective active components can be placed on the coupler assembly planar to build up different configurations. If required, fan-out driver as well as active line-impedance adjusting electronic devices can be placed on the coupler board planar in addition.

According to a favorably embodiment, venting is provided in or on the coupler board. Thus, high power dissipating coupled boards are not deteriorated in their electrical performance by the coupler assembly. Venting can be easily accomplished by providing through-holes in the coupler board.

According to another aspect of the invention, a scalable computer system is proposed, comprising at least a coupler assembly exhibiting at least two connectors for at least two boards, which boards comprise integrated circuits, wherein the coupler assembly provides electrical interconnection between the coupled boards. The electrical interconnection provides signal matching between the coupled boards.

According to a preferred embodiment related to a computer system with SMP-expansion capability, starting from a standard Blade server board, simply all SMP-bus signals are wired to a dedicated SMP-coupler connector located close to the CPU or CPUs, if more than one CPU is present on the board. The connector is easy to access from the Blade-rack/Blade center front side. For the SMP-bus wiring the “simplest” routing passes can be allied to the board-based connecting element, for example an SMP-coupler connector. Wire length differences and associated varying signal delays are tolerated, thus making it easy to add the extended signal wiring to the typically wiring-constraint Blade-boards. No SMP supporting active electronic components are required to be added on the Blade server system planar.

The Blade server board prepared in this manner is providing all SMP-bus signals at the accessible front side of the Blade-rack/Blade center. The board of the coupler assembly is used to interconnect two or more Blade server boards building up an extended SMP system. To enable high-performance SMP, the coupler assembly can preferably apply high-speed connectors on the Blade server board contact sides. The cost consuming part of the connector is located on the coupler assembly, while the mating connector on the Blade server board itself can be implemented as a simple contact pad, thus representing minimum cost overhead on the SMP-Coupler enabled “standard” Blade server board.

Preferably, the coupler assembly comprises signal delay matches. Additionally or alternatively, the coupler assembly can comprise impedance matches, for example for coupling I/O-boards.

Preferably, the coupler assembly can provide one connector for each coupled board which has to be attached to the coupler assembly. Preferably, the coupler assembly is used to couple two or more boards.

As a mating connector can arranged at each of the coupled boards, use of generic boards which are physically and electrically identical is possible.

Each of the mating connectors can preferably be arranged in proximity to at least one CPU on the coupled board, if a CPU is present. The interconnections from the CPU to the mating connector can be chosen as simple as possible. No signal delay matches are necessary on the coupled boards.

The coupler assembly can be attached to the at least two coupled boards at their end faces. This provides easy access to the coupled board as well as the possibility for standardized grid space between the connectors of the coupler assembly.

Favorably, the connector assigned to at least one of the coupled boards can be adapted for hot-plugging. As known in the art, hot-plugging can be accomplished, for example, by enforcing a defined sequence when engaging or disengaging specific electrical connection while plugging in or plugging out the connectors of the coupler board to or from the mating connectors on the coupled boards.

According to a preferred embodiment, the coupler assembly can couple symmetric multiprocessing boards. These can be motherboards or assemblies like Blades, for example.

Additionally or alternatively, the coupler assembly can couple I/O-boards.

### BRIEF DESCRIPTION OF THE DRAWINGS

The present invention together with the above-mentioned and other objects and advantages may best be understood from the following detailed description of the embodiments, but not restricted to the embodiments, wherein is shown schematically:

FIG. 1a, b a preferred system with four single-wide Blade servers as coupled boards (FIG. 1a) and another preferred system with eight single-wide Blades servers with four and two coupled boards (FIG. 1b);

FIG. 2a, b a preferred coupler board with two connectors (FIG. 2a) and a detail of the coupler board indicating signal delay matches on the coupler board as well as venting holes (FIG. 2b);

FIG. 3 an embodiment with two coupled SMP-boards;

FIG. 4 an embodiment with four coupled SMP-boards;

FIG. 5 an embodiment with four coupled SMP-boards wherein each board is coupled with each other board; and

FIG. 6 an embodiment with an active coupler assembly.

In the drawings, similar elements are referred to with equal reference numerals.

### DETAILED DESCRIPTION

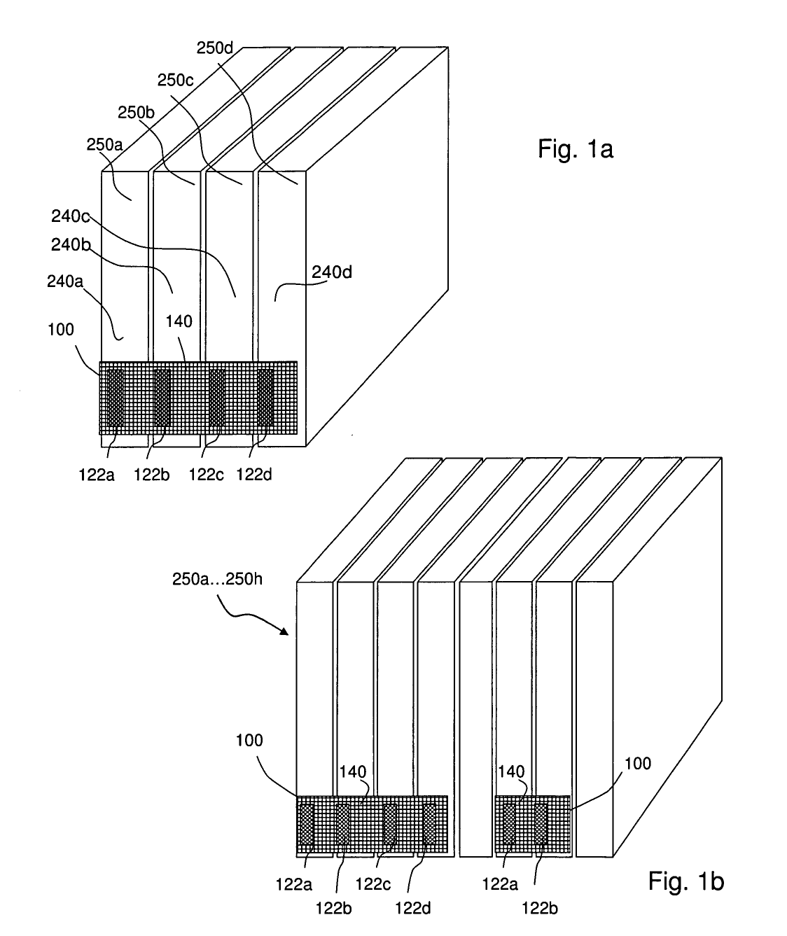

FIGS. 1a and 1b depicts a preferred embodiment of a scalable computer system with a multitude of Blade servers 250a, 250b, 250c, 250d of a preferred SMP-capable system. The Blade servers 250a, 250b, 250c, 250d are coupled by a coupler assembly 100 providing connectors and electrical interconnection between the coupled boards of the Blade servers 250a, 250b, 250c, 250d (not recognizable in the figure). The location of the connectors is indicated by areas with multiple contact pads denoted generally as 122a, 122b, 122c, 122d, which are on the rear of the coupler assembly board. The coupler assembly 100 is arranged on the front ends 204a, 240b, 240c, 240d of the Blade servers 250a, 250b, 250c, 250d (FIG. 1a), providing a standardized grid space between the connectors.

The electrical interconnection of the coupler assembly provides signal matching between the coupled boards.

In FIG. 1a four Blade servers 250a, 250b, 250c, 250d are coupled by one coupler assembly 100, whereas in FIG. 1b eight Blade servers 250a, 250b, 250c, 250d, 250e, 250f, 250h, 250g are shown, where four Blade servers 250a, 250b, 250c, 250d are coupled by a first coupler assembly 100 which is 4-wide, and two Blade servers 250f and 250g are coupled via a second coupler assembly 100 which is 2-wide.

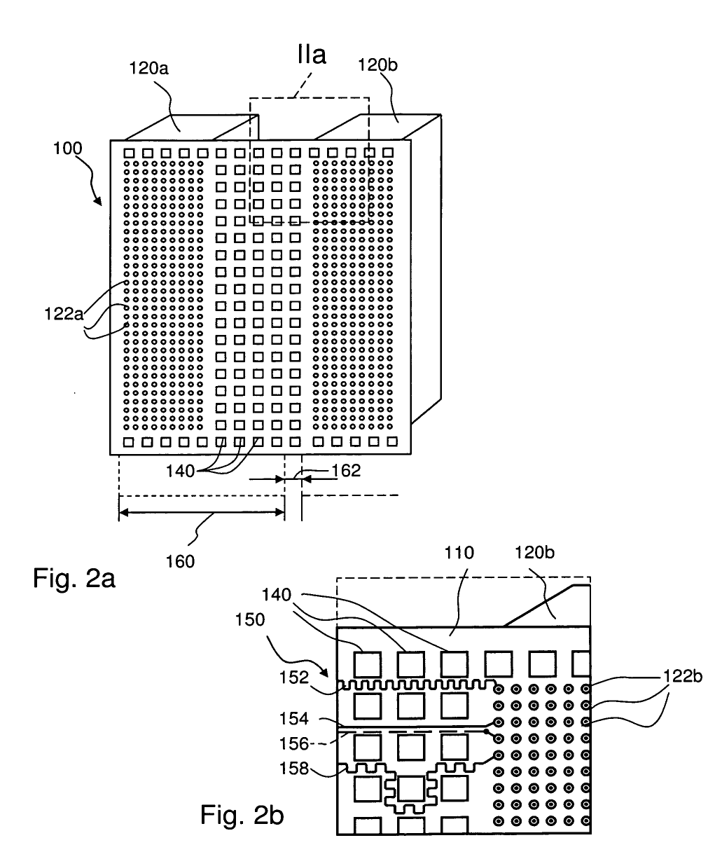

A preferred coupler assembly 100 comprising a coupler board 110 with two connectors 120a, 120b is shown in FIG. 2a. The coupler assembly 100 comprises the coupler board 110, connectors 120a, 120b and a circuitry for solving signal integrity constraints of the coupled boards such as signal delay, impedance or the like. In order to minimize the airflow influence to the coupled boards, it is reasonable to for the coupler assembly to be realized physically as small as possible. For example, for coupling two Blade server boards a coupler board planar of 18 cm² is sufficient.

FIG. 2b depicts a detail of the coupler board 110 of the coupler assembly 100 indicating signal delay matches 150 on the coupler board 110 as well as venting through-holes 140. Only a few venting through-holes 140 are referred to with reference numerals for clarity. Contact pads 120a, 120b at the rear of the coupler board 110 indicate the location of the connectors 120a, 120b on the board 110. For clarity, only a few contact pads 122a, 122b are referred to with reference numerals.

The coupler board 110 can be made of a low loss material such as PTFE. The coupler board 110 can be highly integrated, for example with a 32-layers design or the like. A distance 160 and a clearance 162 indicate a grid space for positioning the connectors 120a, 120b on the coupler board 110 (FIG. 2a). For example, the clearance 162 is the distance between two coupled boards, and the distance 160 is the height of the boards.

FIG. 2b depicts a detail of a signal matching 150 which is provided by the coupler board 110. Between and around venting through-holes 140 electrical paths 152, 154, 156, 158 of varying lengths are arranged and connected to specific contact pads 112b, thus providing defined signal delays for signals traveling between the coupled boards. Path 156 indicates a connection which is distributed over a multitude of layers. Path 154 is a short path providing only a minor delay, for example. Paths 152 and 158 provide adjustment of the signal delay by meandering signal traces.

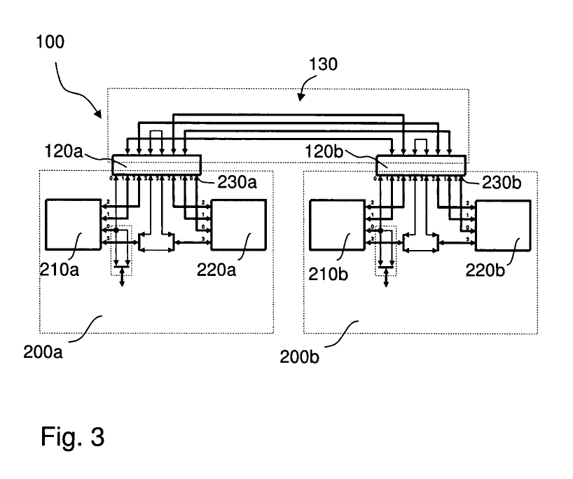

Several embodiments for preferred SMP-coupler assemblies are shown in FIG. 3 to FIG. 6. FIG. 3 depicts a fully 2-way passive SMP coupler assembly 100. Two Blade server boards 200a and 200b are coupled via coupler assembly 100 providing connectors 120a, 120b to which mating connectors 230a and 230b of the coupled boards 200a, 200b are connected. Each coupled board 200a, 200b comprises two processors 210a, 22a and 210b, 220b, respectively. The coupler assembly 100 provides circuitry 130 for settling signal integrity constraints.

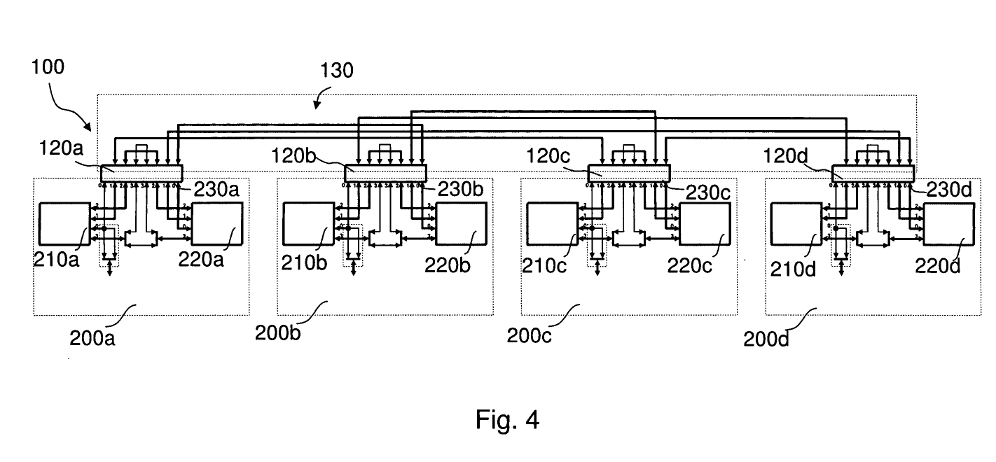

FIG. 4 depicts four coupled Blade server boards 200a, 200b, 200c, 200d coupled in a 4-way mode with a passive coupler assembly 100.

The configuration of the Blade server boards 200a, 200b, 200c, 200d corresponds to the embodiment described in FIG. 3 to which reference is made.

The electrical interconnection circuitry 130 provides signal matching between the coupled boards 200a, 200b, 200c, 200d.

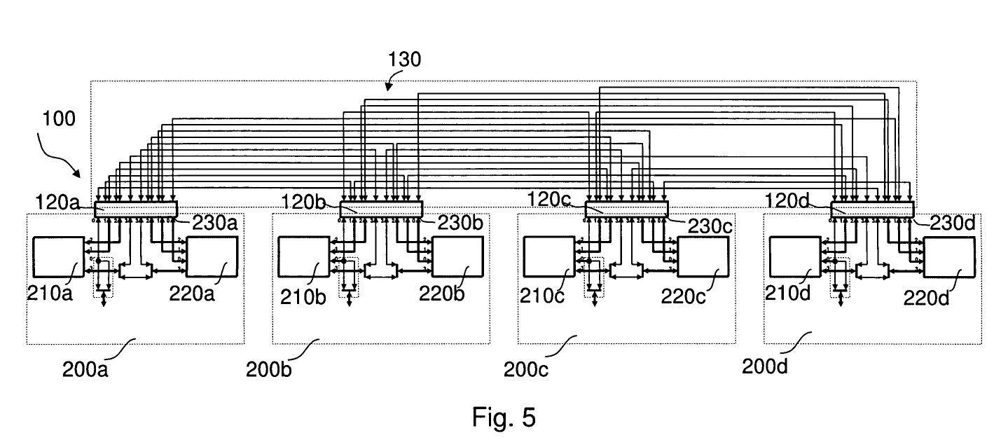

A fully coupled 4-Blade spanning SMP coupler assembly 100 is shown in FIG. 5 with a passive coupler assembly 100. Besides the examples shown, other coupling set-ups can be chosen, such as coupling pairs of boards which are coupled to other pairs of boards, ring coupling and the like.

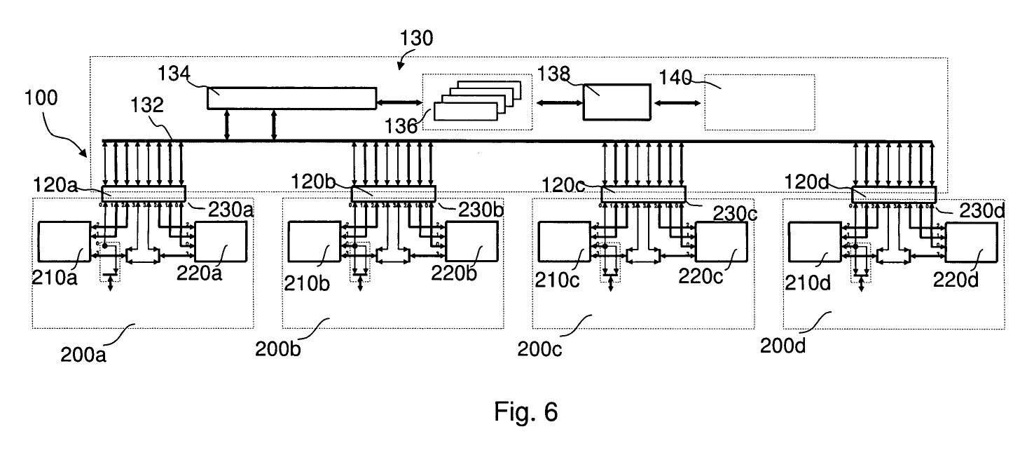

FIG. 6 depicts a preferred embodiment with an active 4-wide Blade server SMP coupler assembly 100. This active coupler assembly 100 can support any SMP configuration for up to 8 sockets such as individual Blade server boards or any combined SMP configuration.

The coupler assembly comprises a FET-switch matrix 134 in communication with a signal trace 132. The FET-switch matrix 134 communicates with a register 136 and is connected to a controller 138. An indicator panel 140 connected to the controller 138 can indicate the state of the coupler assembly 100.

1. A coupler assembly for electrically coupling at least two boards (200a, 200b, 200c, 200d), which boards (200a, 200b, 200c, 200d) comprise interconnected integrated circuits, and which coupler assembly provides high-speed constrained electrical interconnection (130) between the coupled boards (200a, 200b, 200c, 200d), for example CPU-busses, SMP-busses and IO-busses, the coupler characterized in that the electrical interconnection (130) provides signal timing alignment and signal integrity for signals exchanged between the coupled boards (200a, 200b, 200c, 200d).

2. The assembly according to claim 1, characterized in that a signal delay circuitry (130,152,154,156,158) is provided.

3. The assembly according to claim 2, characterized in that an impedance matching circuitry is provided.

4. The assembly according to one of the claim 3, characterized in that one connector (120a, 120b, 120c, 120d) is provided for each coupled board (200a, 200b, 200c, 200d).

5. The assembly according to one of the claim 4, characterized in that one connector (120a, 120b, 120c, 120d) provides coupling of at least two connection types between at least two coupled boards (200a, 200b, 200c, 200d).

6. The assembly according to one of the claim 5, characterized in that the connectors (120a, 120b, 120c, 120d) are arranged on a coupler board (110) in an equidistant relationship to each other.

7. The assembly according to one of the claim 6, characterized in that the interconnection between the connectors (120a, 120b, 120c, 120d) is a high-speed interconnection.

8. The assembly according to one of the claim 7, being designed as a passive device.

9. The assembly according to one of the claim 8, comprising at least an active device (134).

10. The assembly according to claim 9, being adapted to be programmable.

11. The assembly according to one of the claim 10, characterized in that the coupler board (110) comprises at least one FET-switch (134).

12. The assembly according to one of the claim 11, characterized in that venting is provided in or on the coupler board (110).

13. The assembly according to one of the claim 12, characterized in that the venting is provided by through-holes (124) in the coupler board (110).

14. A scalable computer system, comprising at least a coupler assembly (100) exhibiting at least two connectors (120a, 120b, 120c, 120d) for at least two boards (200a, 200b, 200c, 200d), which boards (200a, 200b, 200c, 200d) comprise interconnected integrated circuits, wherein the coupler assembly (100) provides high-speed constrained electrical interconnection between the coupled boards (200a, 200b, 200c, 200d), for example CPU-busses, SMP-busses and IO-busses, the system characterized in that the electrical interconnection (130) provides signal timing alignment and signal integrity for signals exchanged between the coupled boards (200a, 200b, 200c, 200d).

15. The system according to claim 14, characterized in that the coupler assembly (100) comprises signal delay matches (150).

16. The system according to claim 15, characterized in that the coupler assembly (100) comprises impedance matches.

17. The system according to one of the claim 16, characterized in that the coupler assembly (100) provides one connector (120a, 120b, 120c, 120d) for attaching one coupled board (200a, 200b, 200c, 200d) to the coupler assembly (100).

18. The system according to claim 17, characterized in that a mating connector (230a, 230b, 230c, 230d) is arranged at each of the coupled boards (200a, 200b, 200c, 200d).

19. The system according to claim 18, characterized in that each of the mating connectors (230a, 230b, 230c, 230d) is arranged in proximity to at least one CPU on the coupled board (200a, 200b, 200c, 200d).

20. The system according to one of the claim 19, characterized in that the coupler assembly (200a, 200b, 200c, 200d) is attached to the at least two coupled boards (200a, 200b, 200c, 200d) at their end faces (240a, 240b, 240c, 240d).

21. The system according to one of the claim 20, characterized in that the connector (120a, 120b, 120c, 120d; 230a, 230b, 230c, 120d) assigned to at least one of the coupled boards (200a, 200b, 200c, 200d) is adapted for hot-plugging.

22. The system according to one of the claim 21, characterized in that the coupler assembly (100) couples symmetric multiprocessing boards (200a, 200b, 200c, 200d).

23. The system according to one of the claim 22, characterized in that the coupler assembly (100) couples I/O-boards.
